(19) United States
(12) Patent Application Publication
(10) Pub. No.: US 2017/0024095 A1
(43) Pub. Date: Jan. 26, 2017

(54) Multi-media platform

(71) Applicant: Dane Glasgow, Los Altos, CA (US)

(72) Inventor: Dane Glasgow, Los Altos, CA (US)

(21) Appl. No.: 14/998,573

(22) Filed: Jan. 19, 2016

Related U.S. Application Data
(60) Provisional application No. 62/105,188, filed on Jan. 19, 2015.

(51) Int. Cl. G06F 3/0484; G06F 17/30

(52) U.S. Cl. CPC G06F 3/0484; G06F 17/30858; H04L 67/10

(57) ABSTRACT

A multi-media platform for creation of digital and other content. A creation platform connects distributed creators and reviewers to provide extrinsic and intrinsic feedback information to the creator. Analysis of consumption of digital content during the creation process is provided.

### BACKGROUND

The present application relates to a system for creating content in various formats between multiple distributed systems. The functionality may be provided from a central computing device in one location or may be distributed among multiple computing devices. Creation of digital content may be accessed from multiple devices.

### BRIEF DESCRIPTION OF THE FIGURES

FIG. 1 illustrates a collaboration network according to example embodiments of the present invention.

FIG. 2 illustrates a creation platform according to example embodiments of the present invention.

FIG. 3 illustrates a creation process according to example embodiments of the present invention.

FIG. 4 illustrates a collaboration process according to example embodiments of the present invention.

FIG. 5 illustrates a collaboration network according to example embodiments of the present invention.

FIG. 6 illustrates an application according to example embodiments of the present invention.

FIG. 7 illustrates creation modules according to example embodiments of the present invention.

FIG. 8 illustrates a review process according to example embodiments of the present invention.

FIG. 9 illustrates a creation analytics module according to example embodiments of the present invention.

FIG. 10 illustrates a portion of the creation platform according to example embodiments of the present invention.

FIG. 11 illustrates multimedia development according to example embodiments of the present invention.

FIG. 12 illustrates storyline development according to example embodiments of the present invention.

FIG. 13 illustrates creative process according to example embodiments of the present invention.

FIG. 14 illustrates a user interface display on a user device, according to example embodiments of the present invention.

FIG. 15 illustrates a page of digital content having graphic elements, according to example embodiments of the present invention.

FIG. 16 illustrates an example of supplemental options mapped to a storyline, according to example embodiments of the present invention.

FIG. 17 illustrates an augmented reality module, according to example embodiments of the present invention.

FIG. 18 illustrates a collaboration process, according to example embodiments of the present invention.

### DETAILED DESCRIPTION

A creation platform is presented that enables content creators to receive feedback during the creation process. The creative may be a story, book, movie, design, or other digital content. In one embodiment, a teacher creates classroom content and uses the network to access parent, child and editor reviews. The teacher submits the content to the creation platform. The teacher may submit a list of potential reviewers, such as parents of children in the classroom, and also may request the platform to provide reviewers. The content is presented to the reviewers, who read or otherwise access the content. The reviewers provide feedback to the teacher. The feedback may be explicit comments, edits, or mark-ups.

The creation platform provides a global platform enabling audiences to experience content across multiple mediums, as well as to have aligned interactions across such media. The creation platform enables a creator to start with core content and modify, build, develop, and evolve the content.

In some embodiments, the creation platform provides a novel, immersive platform for developing content that enables incorporation of audio, video, audience interaction, social network, and so forth, into the content. The incorporated elements may include musical scoring, wherein the music adjusts according to reading speed of a consumer. The music may match key events to the music. The incorporated elements may include an adaptive glossary, links to games and other media, as well as created elements. The creator may create specific elements consistent with the genre, theme, story element or storyline of the content. Similarly, participants to a project may contribute similar new elements. The applications may be for novels, short stories, poems, plays, instructional tests, movie scripts, and so forth.

The creation platform enables social collaboration or crowd-sourcing in content development. This enables shared story creation, collaborative storytelling, and other collaborations, where the creator is able to provide content during development for feedback, review and analysis. The creator may elect to include reviewers, readers or other users into the content development. In one scenario, a creator may be a set of creators, including an author, a musician, a game designer, a graphic artist, and so forth.

The creation platform enables cross-environment collaboration and interactions, where users may incorporate their physical world into the digital world of a work of content. The creator or user may use their camera to capture real world elements, scenes, characters, action and so forth, which is then transmitted to the creation platform 200 for incorporation into content. The creator may incorporate advertised information into the content, such as to show a character searching using a specific search engine or driving a specific car, and so forth. This may provide a source of revenue to fund projects.

The creation platform also may provide the teacher with additional analytics, including data describing the reviewer's access to the content. This may be aggregated data, or reviewer-specific data. For example, the teacher may want to identify those portions of the content that are difficult to read or understand, and therefore may desire to know the reader's read timing. The reader's dwell time at a particular portion of content may indicate the reader is having difficulty understanding the content. Similarly, if the reader returns to earlier portions, or uses links to other sections for clarity, this gives the author an indication of ease of use or comprehension. In some situations, the time pattern of the reader in accessing the content may also indicate enjoyment.

In other examples the creator may provide content as a book, video, game, or combination thereof. As more and more conventional media are replaced with digital content, broadly distributed via various types of networks, authors now have the ability to have their content reviewed during development. This condenses the development cycle and helps authors and others to create content directed at a specific audience. The review may be crowd-sourced from previously unknown reviewers or may be directed to a specific target group. This information provides feedback to the creator.

The digital content may be anything from books, architectural plans, video gaming, graphic design, to new digital content formats. It may also be used to incorporate ideas and designs from around the world.

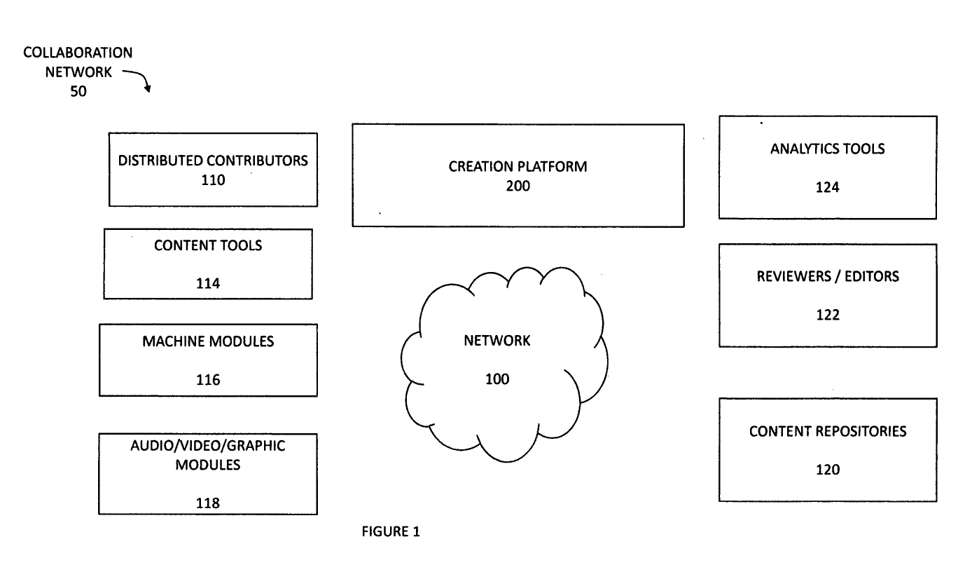

FIG. 1 illustrates a collaboration network 50, including a creation platform 200 to receive content from creators for review and input from collaborators or reviewers. The creation platform 200 communicates with the various participants through a network 100, which may include multiple networks, such as Internet, cellular, and so forth. The creation platform 200 is configured to receive digital content from distributed contributors 110. The distributed contributors 110 are authors or content creators. The creation platform 200 is configured to receive text content, video content, audio content, and other formats consistent with video gaming, quest gaming, graphic design, and/or supplemental information. The distributed contributors 110 may also provide specific instructions or requests to the creation platform 200, such as to request specific data from the reviewers, herein referred to as users, specific types of analytics, or other processing information.

The contributors, herein referred to as creators, may access a variety of tools and resources through the creation platform and throughout the collaboration network. The content tools 114 and audio/video/graphic modules 118 are accessible by the creation platform 200, the contributors 110, the users, and others in the network. Machines modules 116 are automated or computerized inputs and resources for generating creative content.

The users may also have access to review tools, such as Reviewers/Editors 122 for review, edit and comment. This may include error correction tools, mark up tools to highlight or change content, and editors to add material. In some embodiments, the review tools work with content tools 114 to assist in generation of suggested content and graphics. The content repositories 120 store data from the user, including their edits, comments, suggestions and additions. The creator may provide a survey to users, and this information may be stored in the content repositories along with the original content. In some embodiments, the user's consumption of the material is monitored and this information is then stored with the content. Monitoring may include time information, biometric information, such as heart rate, eye movement, pulse, temperature, and so forth. Additional monitoring information may include environmental information, such as lighting, time of day, weather, and so forth.

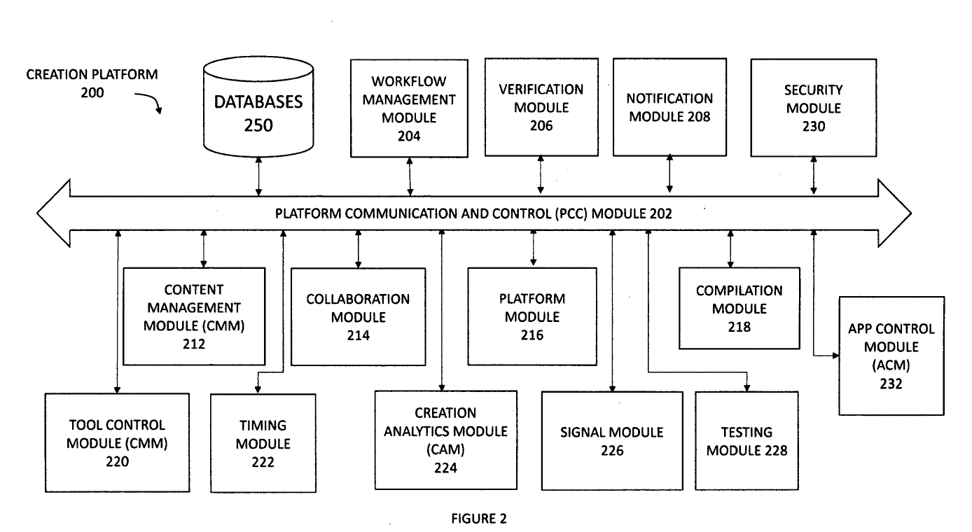

FIG. 2 illustrates a creation platform 200 having a Platform Communication and Control (PCC) module 202 that coordinates operation of the various functions of the platform. The modules are illustrated as within the creation platform 200, various modules may be distributed throughout the collaboration network 50. TPCC module 202 monitors information flow through the creation platform 200 and collaboration network 50 and implements the various workflows that are detailed by the workflow management module 2014 The modules illustrated in FIG. 2 represent some of the operations a creation platform 200 may implement, but is not meant as an exhaustive list of operations.

The creation platform 200, in the present embodiment, includes a Content Management Module (CMM) 212 that controls operations with respect to the created content.

The workflow management module 204 receives information from the creators for processing their content, determines the steps to process the content, and specifies the process to the PCC module 202 and the CMM 212. The workflow may be predetermined, such as where the creation platform 200 has a template for the workflow, or may be custom designed by the creator and/or the creation platform 200. The workflow management 204 has predetermined workflows for specific types of content, such as a process of crowd-sourcing reviews for a book in process. In one example, the author presents the digital content for the book to the creation platform 200 at various stages; at a first stage the review is less structured as the author desires an overall impression of the direction the story is headed. At a second stage the review has added structure, and the author is looking for more specific feedback. This may continue until the book is complete. Other templates are available to accommodate a variety of media formats, content types and creator intents.

The collaboration module 214 coordinates the interactions of the creators and the reviewers, acting to bring participants together as collaborators. The collaboration module 214 controls the portals that creators and users use to interact through the creation platform 200. The collaboration makes communication channels available and monitors interactions. The collaboration module 214 works in collaboration with the platform module 216, which generates the portals and coordinates traffic through the creation platform 200, and specifies verification criteria to the verification module 206. Users present user identification to the verification module 206 which are then cleared for specific access or denied access. For example, creators have different access than users. There are shared resources, but generally, the creators have expanded access to tools, users, and analytic tools.

A compilation module 218 receives information from the creators and the users, which are then mapped to each other and stored in databases 250. The mapping enables the creator to understand the reviewed content and the associated edits. The creator may specify a specific mapping or compilation technique desired. For example, the creator may desire to separate out review materials from a specific group of reviewers, and this information would be compiled separately from the other information.

The creation platform 200 includes multiple testing and analytics functions, which are controlled by the Tool Control Module (TCM) 220. These assist the creator in generating content, and include creation analytics module (CAM) 224, testing module 228, signal module 226, and timing module 222. The CAM 224 provides analysis of the information received from the users, including both extrinsic and intrinsic information. CAM 224 receives information from signal module 226 and timing module 222 related to the user's consumption of the content. This may be biometric information, reading time information, the order of access within the content, environmental information and other particulars monitored during the user's access to the content.

In one example, the user starts reading a digital book and reads pages at a constant read rate until accessing page 22. On page 22, the reading stops. This may be due to interruption, boredom, technical error, researching information, or linking to other content. As the user returns to reading, the read rate increases, which may indicate interest. When the user gets to page 102, they start linking to video content. Then the user returns to page 44, possibly to review information. The CAM 224 uses all of this information to make determinations about the mood of the reader as they access the content. The material may be too difficult for a young reader; the material may be boring in some spots, and these can be edited by the creator; the material may be more interesting when coupled with graphic or video elements. The analysis is based on the digital content, media, and the purpose of the creator, among other considerations.

In one embodiment, a story is provided in digital content form to the creation platform 200. The digital content includes a portion that displays as text, and other portions that may be displayed as video, audio or multi-media. The story content includes links to other content, both within the story as well as other digital content. As a user consumes the content portions, indicators of the user's interaction with the content are monitored and recorded; this may done in real time, or may be stored at the user's device for uploading to the system periodically or at a specific time. The information is provided to the creation platform 200 for analysis and feedback to the creator. In some embodiments, the creation platform 200 receives an indication as the user changes pages or moves through the content. This information may indicate an interest in that portion or section; similarly, this may indicate difficulty in understanding the portion or otherwise. Depending on the signals available from the user's device, there are a variety of possible connotations that may be made. The creation platform 200 may adjust their monitoring schedule according to the progress of the user, so as to avoid over sampling of information as well as to avoid redundant or overly inclusive data. The creation platform 200 may request information from the user and/or the creator during this process. In some examples, the creation platform 200 may provide a notification to the creator of a particular action by a user, and may suggest a modification of content or suggest the creator present the user with a question or comment. In this way the collaboration module 214 assists both the creator and the user in the creation process. The collaboration module 214 uses this information to learn and adapt to each creator; if a first creator does not act on a first type of suggestion from the creation platform 200, the collaboration module 214 may alter the first type of suggestion or avoid using that suggestion for the first creator. In working with a second creator, the collaboration module 214 may continue to use the first type of suggestion. In this way, the collaboration module 214 may adapt to types of content, specific creators, and other aspects of the creation process.

The creation platform further includes a timing module 222 that monitors the timing elements of the users. The timing module 222 calculates read rates, dwell times, and other types of access time for a user's access to content.

The signal module 226 receives information from the user that quantifies the mood of the reader, wherein the mood is the reader's attitude toward the content. Signals include biometric information, environmental information, social and other monitored information. The creation platform 200 uses the monitored information to determine the user's interest and use of the content. For example, eye movement may be detected and transmitted to the system and may identify stimulation or interest level. The eye movement may further tell if the reader is bored, sad, happy, curious, and so forth. Speed readers may be identified by their eye movement patterns, and content may be adapted accordingly, such as to simplify the text. Similarly, where the reader dwells on a specific portion of the content, the creation platform 200 may develop feedback for the content. CAM 224 makes determinations based on these signals and provides this analysis to the creator.

The signal module 226 may receive packetized data or continuous streams of data. The information and receipt format is a function of the creator, content and users. This may be continuous monitoring of a user during a portion of content, such as just prior to climax of the story, to determine the user's mood at each point. Similarly, the monitoring may be to receive sampled data that does not typically change instantaneously, such as blood pressure, heart rate, blood pressure, oxygen level, eye dilation, skin temperature, and so forth. The monitored information may also consider connectivity, current user activity, current environment, user's scheduling and other considerations that may induce stress, elation, frustration or otherwise bias the measured data.

The signal module 226 in one embodiment quantizes the data measured to create a composite score of the measurements of interest. This composite score is compared to values prepared by the creator and/or the creation platform 200. The signal module 226 receives a wide-variety of information and signals related to content and consumption. The signal module 226 may also receive information from the creator indicating the current state of the creator to identify the most creative situations or when the creator is most productive. The CAM 224 may provide the composite calculation and make up of signals to the signal module 226; in response the signal module 226 requests or monitors the specified information and quantizes and/or forms the composite score accordingly.

Monitoring user's and/or creator's facial expressions, eye movements and so forth may provide specific information that is provided to the CAM 224. The CAM 224 may incorporate machine learning techniques, such as neural network techniques and other expert system techniques, to learn and adapt to the volume of content, signals, statistics and other information processed in operation. The CAM 224 communicates with the other modules within the creation platform 200 to develop these learnings. The result is an effective expert system to evaluate the creation process and provide insights, guidance and other analytic information applied to data. Some information may be in the form of notes and guidance provided to the creator for their implementation. Other information may be used to provide metrics as to storyline. For example, the CAM 224 may analyze a given storyline and the user responses to determine timing of the climax and resolution of other parts of the storyline. As a story typically includes an exposition, rising action, climax, falling action and resolution, the timing of these in a book version of a work of content may be different than the timing in a movie or game. Similarly, the user's feedback from a game may be used to adjust the timing, or components of the story, in the book, movie, and so forth.

Signals 226 work in collaboration with other modules to supplement tracking by the creation platform 200 of user behavior, such as consumption of specific portions of content, sharing of content, user direct feedback, and others. In one example, CAM 224 determined that a substantial number of users made similar comments to adjust the timing of the storyline. The CAM 224 translates this to analytic information to inject timing suggestions to the creator. The timing suggestions may be over of the storyline elements and points over the current timing scheme to show the adjustments to make. The creator may then make all the adjustments or may make individually selected adjustments to test edits and modifications of content.

The creation platform provides mechanisms for enhanced understanding of content, wherein glossary, index or preface materials are accessible throughout the story. When a user comes to a character, an icon for that character may be presented on the screen edge, enabling the user to go to content about the character for clarity. The user may be directed to a list of characters, table of contents or other material to review information, such as character information. The ability to navigate easily through the text and return to the point where they were reading creates a smooth experience. This also allows the user to add information or ask questions about the characters.

An author or creator of the content is able to access feedback from readers through the creation platform 200. The content may include direct communications between the creator and the user. Such communications enable the creator to gain a deeper understanding of the content and its impact. User feedback information may be supplemented with context information, such as the time of day. Supplemental information may also identify whether the user is commuting and reading while riding on a bus, train or plane. The supplemental information may identify the type of device in use, such as mobile phone, tablet, personal computer, and so forth. The feedback information may also include comments and notes directly from a group of readers, such as in a social network. The reader may enter this through a chat session or may supply the information directly to the creator through collaboration module 224. The creator may also supply additional information through the system, which is then incorporated into the content provided to the user.

In one example, the creator is a wedding dress designer and the digital content is the dress design. The designer desires to create a new style and wants to incorporate ideas from Japan. The designer, or creator, may specify to the system that the reviewers or users must be Japanese or live in Japan. This provides a unique perspective to the designer.

In another example, the creator is a fantasy author, writing a new series that will also have a video format and a game format. The original content, or core content, is the storyline written as a book. The creator writes the first few chapters and establishes characters, setting and storyline. At this point, the creator would like to invite some graphic and video designers to review the content and give their perspective on preparation for a video project. The creator sends instructions to the creation platform 200 indicating that no analysis is required at this point, but requests the reviewers be graphic designers and video designers. The creator is interested in their comments and direct feedback. In addition, the creator sends instructions to be given to the reviewers. The creation platform 200 sends out an invitation for the requested reviewer group. As users respond, the creation platform 200 provides the digital content and instructions. The users provide the feedback to the creator, who then is able to prepare the content for video or gaming. The creator may change a character or setting or may modify aspects of the content based on the feedback. The creator may provide a monetary incentive to the reviewers or may enlist their help in building the video or game. In this way, the reviewers may be competing for work.

The creation platform 200 includes a testing module 228 that implements tests according to the digital content format and/or the creator's instructions. For video or game content, the testing module 228 may be used to build a test environment that is distributed to users to try the content. The testing may be for enjoyment, ease of use, and functionality. The testing may be stress testing, where the users are given a set of criteria to try and find glitches.

A security module 230 maintains the security of the creation platform 200 by preventing unauthorized access to the system. This includes detecting and resolving hacking and malware entry or attempts. The security module 230 may implement digital rights management (DRM) or other control over content. Specific content media, such as a physical book or video, may have information embedded to enable DRM. In some embodiments randomized questions are used to ensure each user and creator has rights to the content they are accessing or attempting to access. The security module 230 may implement anti-plagiarism features to monitor contributions and activities to avoid potentially illegitimate use or presentation of content.

The security module 230 may also implement rules associated with open source or sharing environments to ensure that any applicable agreement, licenses or rules are honored. Where the creator desires to share content, the creation platform 200 may provide shared content and provide attribution and license information as provided by the creator. The creation platform 200 may also include a mechanism to evaluate software, such as code for an app or game, wherein a search is done or a tool is accessed to ensure the integrity of the content that is developed and/or published through the creation platform 200.

The App Control Module (ACM) 232 functions to interface with the applications for interacting with the creation platform 200, including specific operating systems, device types, communication protocols and versions of the app. The ACM 232 may dynamically update information on a user or creator app by sending the information over a network to the device. The creation platform 200 may support a variety of formats, including videos, SMS, games, and so forth, where content information is shared between multiple formats. The ACM 232 controls these interactions and interfaces for smooth, uninterrupted communication and data sharing. Feedback from any of a variety of systems and device types is processed through the creation platform 200, and the ACM 232 may be required to interact with gaming controllers or other peripherals.

The creation platform 200 is an interactive insights production platform that enables storyteller to share and test their work. This enables authors, artists, musicians, designers, and so forth, to better understand their audience by connecting with them during the creation process. The creation platform 200 enables creators to iterate and improve their work product. In this way, the creation platform 200 provides for dynamic creation, where a creative may continue to evolve. The creators may use the creation platform 200 to connect with the audience to experience and test the content. The testing may involve reading, listening, viewing, operating, interacting, and so forth, to provide the creator with user data. The data includes explicit information and implicit data based on analysis and evaluation. The creation platform 200 provides analysis capabilities, which may be supplemented by external tools that may be accessed through the platform.

The creation platform 200 incorporates dynamic music accompaniment to content as text is accessed. Automated playlists may be mapped to content and added as story points are accessed by the user. These playlists may be personalized for the user, suggested by the user or designed specifically for the content by the creator. The users may provide feedback as to the playlist and may add music options and alternatives.

In one embodiment dynamic accompaniment is implemented through the platform module 216, where supplemental content is created, added, tested and modified. The platform module 216 operates according to a workflow for tagging sections of content. The workflow details interactions, storage and implementation of the supplemental material. The tags are stored in a lookup table or other retrievable format. The platform module 216 provides a user interface that is user-friendly (author-friendly) to identify sections of a book for an accompaniment score. The functionality of implementing accompaniment as a musical score for a work, may be provided as a service, such as software as a service, or as an application or tool. The tags in a book could identify specific styles, environments, scenes, or changes in aspects of the story; these may be added by the creator or user at time of creation or painted over text or video with a plug-in, such as for word processing applications or video collaboration applications.

Creators may limit the number tags and apply a word count between music changes, and may implement smooth transitions between musical changes.

In one embodiment, creators or authors create content without music, and then choose from a number of audio abstractions, such as ambient, action, romance. The list may be presented in the user interface along with samples of the content, playlists, and alternate music. Sounds may also be implemented in a similar manner. The user interface presents various options to the user, such as UP and DOWN controls to implement cadence changes. The creators may desire to change aspects of the music, such as to increase the bass, or play at a faster tempo or in another key. In some embodiment, the creation platform 200 enables these modifications.

The creation platform 200 provides tools to creators and users to enable a simple process that is abstract and flexible. This also requires maintaining sufficient detail to augment and enhance the reading experience. Music adds significantly to the mood of the user and encourages engagement. In a digital version of a book, the creators are not limited by the physical book, but can implement a variety of digital enhancements. These may include music, sounds, vibrations of the user device, coordination with augmented or virtual reality. For example, the user device may shake with a strong drum or clash of cymbals.

After the author completes the abstract he or she would be able to apply one of a variety of genres, such as contemporary, popular, or renaissance, and so forth, according to the content, target audience and desired effect. This part could be broken into sections similar to how books are tagged, Fantasy, sub-genre Weird Fiction or Dragons, OR a more directed approach in which the author selects a piece of music that fits a section and we generate the rest. In some embodiments, the tagging system may utilize existing genre tags to aid in the application of appropriate music to a given content. In one example, the creator provides genre information to creation platform 200 such as Fantasy, Weird Fiction, Dragons, and the creation platform 200 determines a score. In another embodiment, the creator may mark sections of a work and specify musical accompaniment tags manually for each part of the storyline. There are a variety of ways to implement the musical accompaniment.

The creation platform 200 compiles these abstracts and makes them available to share, update, and expose to the community so as to allow both professional and amateur composers to apply their own music. There may be multiple versions created and compiled in the compilation module 218. The compilation module 218 maintains the various versions, labeling and mapping within the databases 250 so as to coordinate supplemental and developed information, including accompaniment information. The accompaniment information includes digitized musical data for various songs and portions, as well as the entire score of a portion or entirety of a work, as well as the associated with the timing. The compilation module 218 enables users and creators to prepare mash-ups of the various options for effect. A meme version of a story may be prepared by the creator for engagement with a specific audience or may be available for use by others for a fee.

A blending algorithm would be applied for all transitions, including moving around through the book or story, so that music fades in and out, crossfades, pauses while navigating, and so forth. These transitions and interactions add a richness to the experience for the user. The user's feedback and reaction to the music provides key information to creators. The user may be asked to consume the content without the music and then again with the music, or some specific portions of content. The pre-music and post-music implementations provide comparison data to measure impact and effect.

As there is much data widely available around individual tracks of music, an audio abstract module is adapted to retrieve information from a creator's or user's personal music library. This enables the user to create a unique listening experience. The various scenarios using different playlists may be presented to users for their review of selections in order for the creation platform 200 to learn and provide a smart recommendation engine supporting global, local, personal and other type recommendations.

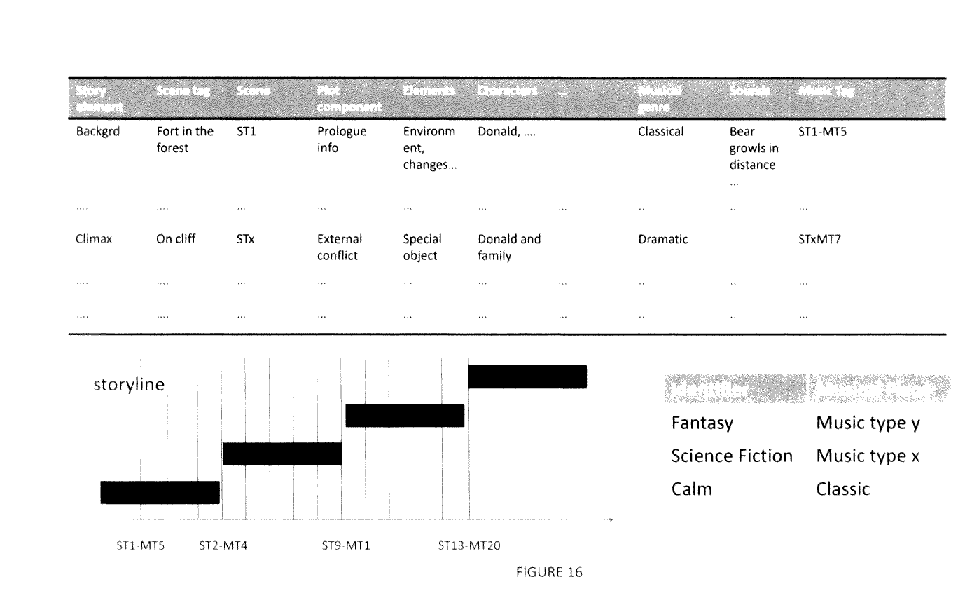

FIG. 16 illustrates an example of a storyline and the corresponding accompaniment, which in this case is music. The storyline is broken into portions having a common theme or characteristic. The creator may specify breaks or tag specific points in the timeline, either identifying the time at which events occur or the chronological sequence of events. The creation platform 200 identifies each of the tags with a specific storyline tag. This provides insertion, deletion, or change points for supplemental materials or content, including audio accompaniment. The tags are positioned throughout the story and music may be inserted at a tag. An example piece of a storyline is illustrated having four portions ST1, ST2, ST9 and ST13. A musical piece is inserted at each of these storyline tags. Specifically, MT5, MT4, MT1, and MT20 are the music tags for the different musical pieces. The musical pieces are organized in a table or mapping to associate each musical tag with a musical piece. In the example illustrated, the musical pieces are organized according to genre. There may be any of a number of ways to organize the music so as to enable the creation platform 200 to insert the music into the storyline. Additional instructions may be included to specify the volume, key, fade in/fade out conditions, and so forth.

The analytics engine, such as CAM 224; processes a variety of data to produce insights for the creator. Some insights are developed by the creation platform 200 and others are made by the creator in response to the data from users. The insights are directed to the type of media, such as textual, visual or audio processing; the users may suggest another font or spacing for text, or may suggest a different color scheme for the video. The CAM 224 may compile information and calculate scores, such as how the user would rate the content. This may be a ranking scheme provided to the user to which they respond with a score for the content. This may be a comparison of the content to another work product or known work. The CAM 224 may determine whether a user would promote the content to others, such as to evaluate postings to social media or sharing the content with others. The CAM 224 may analyze the user engagement with the content and compare among the set of users, or compare to other works. Analytics may further monitor consumption of material to draw conclusions; users that read through the material quickly to get to the next chapter may be more engaged than users that pause reading in-between chapters. The user's reading speed, number of length of interruptions, research types and rate, times they returned to earlier portions of content, questions presented to the creator, and other behaviors are used to make determinations that the creator can use in continuing the creative process. The creation platform 200 may monitor the user's use of external content, such as social media, searching the web, reading news and blogs, collaborating with friends, and seeking other information. This provides more insight and data points for the creator.

The creator uses the creation platform 200 as an advanced research, editorial and even marketing portal. The creator is able to gain insights from an unlimited group of users. The creator may be specific in detailing the criteria for review, as the creation platform 200 has capability to implement a wide variety of these criteria and present the results to the creator. The creator accesses the creation platform 200 as a portal to manage their digital content, view collected data, review insights provided by the CAM 224, and interact with their audience.

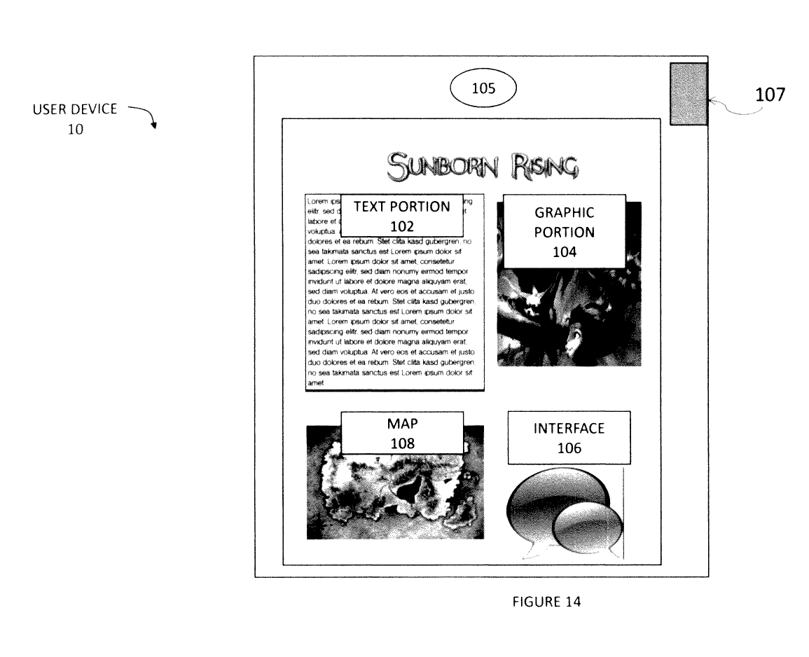

The app may run on a user device, such as a mobile device or other display device capable of communicating over a network. FIG. 14 illustrates a user device 10 for presenting interactive content, where the content is displayed on a user device 10 as a text portion 102, an interface portion 106, and optional graphic portion 104 and map portion 108. The text portion 102 presents a story or textual information for the digital content, which is illustrated as a book. The interface 106 is used to communicate with the creation platform 200, and may be a wireless communication module having messaging functionality. This enables the user to contact participants through the creation platform 290. The user device 10 may also include monitoring sensors, such as a camera 105, a microphone 107, capacitive elements (not shown), and so forth. As the user is reading the content on the user device 10, the camera captures eye movements, which are transmitted to the creation platform 200. The app running on the user device 10 monitors how long each page is displayed to the user, as well as movement forward and back through the content. The graphic portion 104 may change as the reader proceeds through the story. The monitoring sensors enhance the ability of the creation platform 200 and the creator to monitor the user's activity and behavior as they interact with content on the user device 10. The monitored information is provided to the system via the interface module 106.

In one example, the creation platform 200 is able to monitor reading speed of a user while reading content on user device 10. The reading speed and patterns of use are then analyzed by CAM 224. The reading speed may be analyzed on an individual basis for personal experience understanding or enhancement. The creator may experiment with different modifications for a given user. The results may provide insight into more general audience preferences. The CAM 224 may analyze a group of readers to identify trends and preferences for the group. This information may be considered specific to the group, or may be interpolated across multiple groups to predict trends and anticipate future uses. This may be used to develop a sequel to a current story.

The device 10 having an app installed for interaction with creation platform 200 may operate without network connection as a stand-alone application. During off-line operation, the app continues to monitor the user per the instructions associated with the content. The data is stored on the user device 10, and is uploaded to the creation platform 200 when network connection is restored. The uninterrupted operation, provides the user freedom without missing review information for the creator. In addition to the features described with respect to user device 10, the user may also edit the content, provide comments, and mark ups which are stored on device 10. The user may provide audio notes which are provided to the creation platform 200 for the creator. Audio notes are particularly useful, as they provide context that a written note may not convey.

As the analytics are expanded to include additional information, such as biometric information, the data on a user or group of users becomes rich and complex. The matrix of data may include insights into the user's interest level and engagement may be determined by various measurements, such as eye movement, heart rate, blood pressure, oxygen level, or other biometric information. This data may be weighted to emphasize certain variables over other information. For example, an instructional text may weight comprehension indicators as more important than enjoyment indicators. Similarly, other information may provide details about the user, their interaction with the content, the environment and context of the user's environment. This information is received as signals to the system from the current use case (given user and given content) but may be used to give the creator insight into other formats. For example, the feedback on a story or book may be used to determine if the story would be well-received as a game.

The biometric signals, such as to identify eye movement while reading or accessing the content, may be mapped to other biometric signals, such as heart rate, monitored through a wearable device, to provide a composite score. Where eye movement indicates boredom but heart rate is elevated, the CAM 224 may determine that the reader is spending more time on a page because they are envisioning the scenery. Physically measurable signals provide information to the system that is compiled, weighted and calculated into a variety of scores, each of which provide insight into the user's experience.

A variety of signals relate to the user's access to the content, such as pupil dilation, facial expression or dwell time in reading. Where the content is provided on a device having a camera 105 or other monitoring module, the device may track the user's access, such as to track reading of the text portion. The tracking may identify portions of the text that are particularly interesting or where the user spends more time. This may indicate material that is of interest to the user or where the user has difficulty getting through the material. These signals may be part of a composite signal which is used to analyze the user's experience. The creation platform 200 may also solicit or determine information about the user that may be used to predict content of interest to the user. Additionally, the creation platform may rate or organize users to coordinate review. For example, one user may be particularly good at reviewing games, while another may be better at reviewing text. This enables the creation platform to maximize useful information and reduce or filter out less useful information for a given content review.

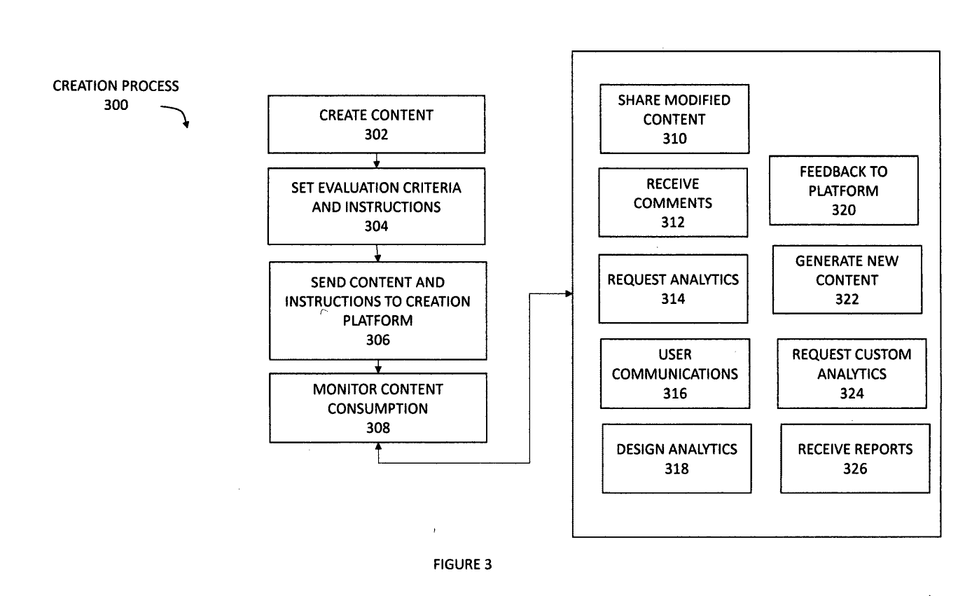

The user's comments and feedback are important to the creator during the creation process. FIG. 3 illustrates a creation process 300 starting when the creator creates content, 302. The creator sets the evaluation criteria and provides instructions for the review, 304. Each creator may specify different criteria for each work of content. The creator then sends the content and instructions to the creation platform 200 through the network 100. The creator may monitor content consumption 308 through a creator device (not shown) that communicates with the creation platform 200. Monitoring may be automated to retrieve information periodically, or the creator may be notified by the notification module 208 of the creation platform 200. The creator may also receive analysis data and information as desired. In response to the information from the user, the creator has the option to modify the content, to enable auto-generated modifications as calculated by the CAM 224, or take other actions. The creator may share any modified content, 310, with others through the creation platform 200. The creator may receive comments, 312, from users or from the CAM 224. The creator may request analytics, 314, which may be an automated request in response to a notification from the notification module 208 that sufficient data is available for analysis. The notification may provide options for analysis based on the current data. The creator may initiate a user communication, 316, to send the user or users information or ask questions. The creator may present questions to readers at what they consider key moments, such as chapter completion, story conclusion, story climax, story resolution, and so forth. The creation platform 200 may suggest storyline points at which to inject questions to the users. Questions and interactions between creators and users may be author-based questions as to the user's emotions or mood during consumption of content, the user's opinion of character traits and so forth. In one embodiment, the creator provides the reader prologue information that gives their goals and the tone they want to set in the story. The prologue may give insight into the characters, setting, scenes, action, plot, resolution, moral of the story, and so forth. This gives the reader a scorecard to measure the content. In other embodiments, the creator provides such a scorecard to the user requesting information after they complete the content. This is compared to the expectations of the reader and/or creator prior to consumption of content. The CAM 224 provides analysis of this information for the creator.

In one embodiment, creators and user may control spoiler-type information that gives away an ending. This may be used when a user does not perform as expected, such as where they are taking too long to complete a task. This provides future information to users, and may be used to change the experience or to test different scenarios. As the digital content may be dynamically modified, the spoiler may result in the creator changing the storyline or information.

The creator may request additional information from the user, including their promotion of the material by referral to others, a review by indicating the number of stars for the content or portions of the content, and so forth. The creator may request specific feedback as to what they dislike or feel needs modification. The creator may also request personal preferences and information from the user, such as favorite genre, most recent book read, most recent movies viewed, the social networks in which they engage, their hobbies, their educational level, their profession, and so forth.

The competition control module 270 functions to set up, monitor and complete competitions and contests. The competition control module 270, in some embodiments, runs a writing contest for creators and users. Winners of the contest are published, and may result in additional creators collaborating to build additional content, video and so forth.

The creation platform 200 may be used to create resources for users and creators. In some embodiments, a list of content available is created for a target audience. This may be a reading list for children according to age of reader, genre of content, or other considerations. The reading list may be directed to fantasy stories, science fiction stories, biographical novels and so forth. The reading list may be organized to increase with difficulty, so that students may progress through the lists, gaining credits for completed works. Teachers may inject questions for students throughout the text, such as random questions, to ensure the student comprehends the material. The creation platform 200 may establish a reward system for use of the system, such as progress through a list. The creation platform 200 may suggest book selections for individual readers or groups, such as a class of students. Teachers may act as surrogate creators presenting works by other authors for education of their students. The teachers may compile the edits, feedback and information to adjust curriculum or otherwise enhance the educational environment. The display portion on a user device includes a progress bar and various controls to allow interaction with content, creators, resources and others.

Participants may be teachers, parents, coaches, employers, and so forth. In some embodiments, content is provided by an employer to gain feedback from employees. This may be done is an artistic or fun way, so as to increase engagement of the audience.

The creator may design new analytics for the CAM 224 to generate and implement information received from users. The creator may also provide feedback to the creation platform 200 to improve performance of one or more of the modules within creation platform 200. For example, the CAM 224 receives inputs indicating actions taken in response to analytics performed. The CAM 224 uses this information to adapt to the creation process 300. The creator may request custom analytics, 324, which may be a unique algorithm or mechanism for calculating user behavior and mapping to the content. The creator may choose to receive reports, 326, such as standard reports generated by the creation platform 200. In addition to modifying content, the creator may generate new content, 322, and submit the new content to the creation platform 200. These interactions require the various modules and devices to communicate with each other according to predefined or machine-negotiated protocols and formats. Some of these communications are asynchronous, and each device may interact according to their own timing. Others are synchronous, such as real time processing of information from users. All of this communication and data sharing is managed by the creation platform 200 according to the workflow specified.

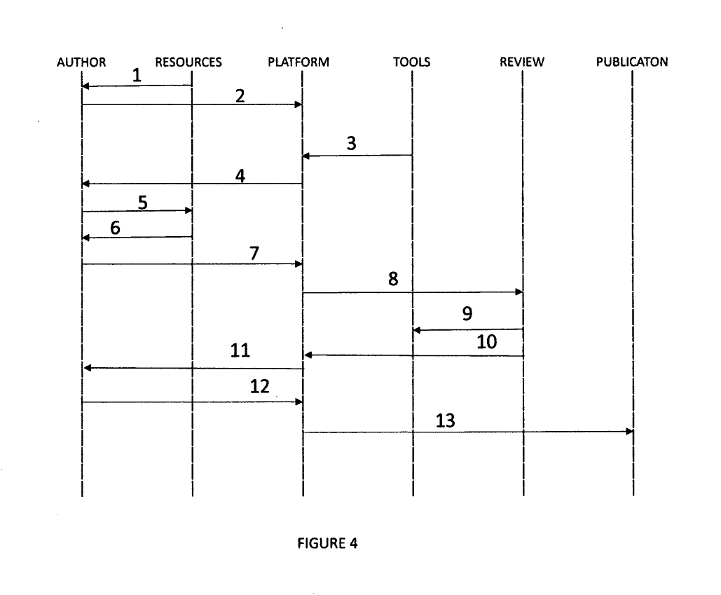

One example of a workflow is illustrated in FIG. 4, which is a creation process for a book. The first transaction, 1, is for the author's device to interact with resources. The resources may be used to apply graphics or design the layout of the book. The author's device then transmits the content to the creation platform, 2. The platform accesses tools and provides information to the author, such as to request review criteria and further instructions for managing the content. The platform may provide general guidance on books of the genre of the content. The platform may indicate the type of reviewers to invite, and may suggest other content that the author may consider using in the current content or to add links for the reader. The author may use resources to implement the information from the creation platform, 5, 6. The content is transmitted to the platform, 7, where it is prepared for sending to the readers. The platform stores the content in databases 250 and identifies a workflow for the review. The author may identify multiple potential storylines for the book, and this information is stored in databases 250 also. The content is then sent to the reader for review. The reader may access review and editing tools, 9, and provides comments and edits to the platform, 10. The reader may provide the information in parts, or the platform may request continuous feedback and updates, including access to monitor information. The reader information and any analytic information requested is transmitted to the author, 11. The author may then implement suggestions, comments, edits, or may reject this input. The author may modify content in response to the feedback and analytics. The final version is sent for publication to the platform, 12, and published, 13. The steps provided in FIG. 4 are given as an example; there may be more or fewer steps involved in other processes.

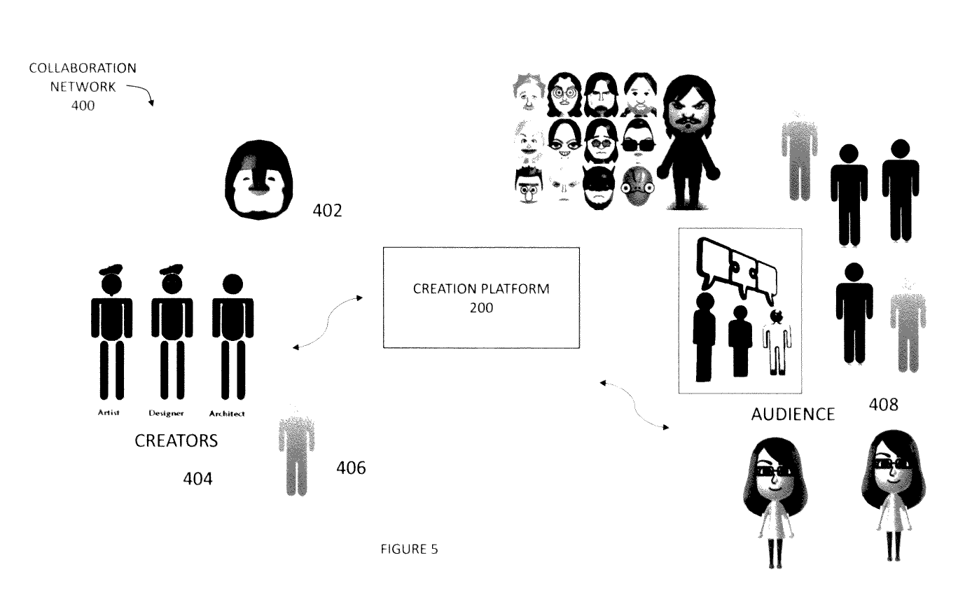

The creation process may employ a small or large group of participants. The creator may be an individual or may be a team of contributors. FIG. 5 illustrates a collaboration network 400 having creators transmitting information to and receiving information from creation platform 200. The creator may be a single creator, such as individual creator 406, or may be a group of creators, such as group 404. In one example, a group 404 included two authors, one graphic designer, one video designer, and one game designer. In another example, a group included an architect, a contractor and a designer. As discussed hereinabove, the creation platform may be used for any of a variety of creative projects. In one example, an inventor wants to perfect an idea but wants to get review and ideas for improvement; the inventor transmits the invention to the creation platform, and invites specific subject matter experts to review the invention. The review criteria for the inventor may be very different from the review criteria of an author; however, the creation platform 200 may be used for both collaborations. The set of reviewers, or the audience 408, may be very different for the two scenarios as well.

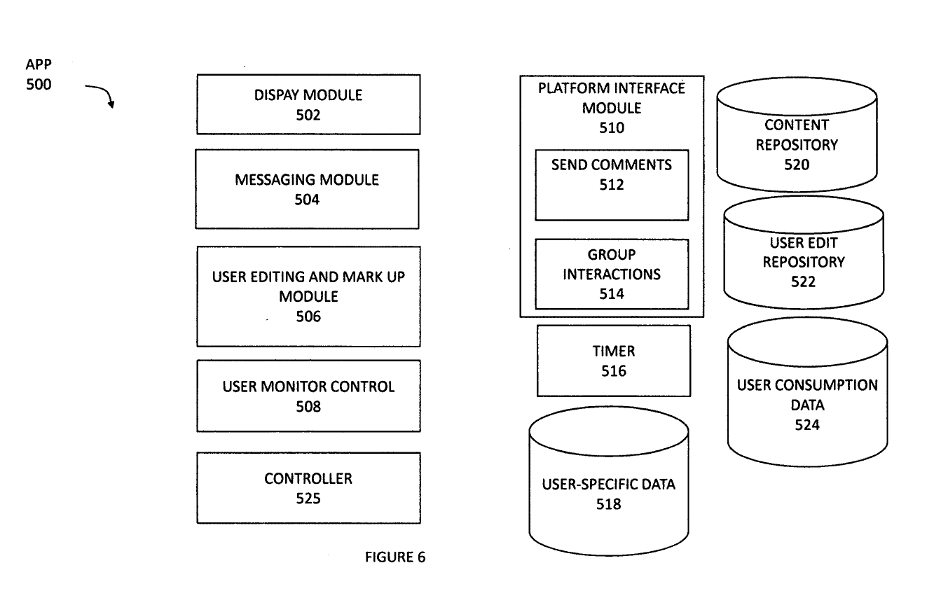

The user interacts with the creation platform 200 through an application, such as an app on a mobile device. FIG. 6 illustrates components of an application according to some example embodiments. The app 500 includes a controller 525 that controls operation of the app, communication with the user, and interaction with the creation platform 200. A display module 502 controls the look and feel of the content on the user's device. The display module 502 determines the best configuration for the content and may adjust based on the user's device settings or the ambient light. The display module 502 also adapts to any touch-screen inputs that enable user interactions. The display module 502 may format the display, size the various portions of the display and enable the user to adjust the display for their comfort. For example, in some embodiments, the user is able to resize the display portions; the user may want to have only the textual portion display while reading, and only the graphic portion when selected. The user may want to move the position of the various display portions to have the map on the top of the display and the text on the bottom portion. The controller 525 stores the user preference information in the user-specific data 518, which also stores monitored data, such as eye movement, read rate and other user behaviors.

A messaging module 504 controls messaging with the app, and specifically, through the creation platform 200. The messaging module 504 may present a visual messaging mechanism in the interface portion. A user monitor control 508 supervises operation of user monitoring, including interfacing with the sensors, camera and mechanisms on the user device. The controller 525 specifies operation of the modules within the app and coordinates operations with the platform interface module 510 enabling a variety of interfaces. The user may send comments 512 for the creator or participate in group interactions 514. The app 500 also includes a timer 516 for timing operations and monitoring behaviors. The app receives digital content and stores the content in content repository 520. The user edit repository 522 stores the user's comments and edits made to the digital content. The edits may include highlights, notes, references, corrections, and markings. The comments may be in-line with the content or may be provided as written or audio notes. The comments may include links to other references and resources. Groups of users may collaborate together to provide comments and suggestions. The comments may also highlight favorite portions or ask for explanation. The user edit repository 522 also keeps track of the user's access to the information, including time and location in the content where a user stopped reading. This information is used by the user to reengage with the content. This information is also mapped to the user consumption data 524 and used by the creation platform 200 to analyze behavior information.

The app receives content and other information from the creation platform 200; the information may be used to update the app on the user device. The app may operate off-line when content is stored in the content repository 520. The user consumption data 524 stores information related to the storyline of the content. The storyline may have multiple paths, turning points, and triggers that lead to other content. The users interact with the content following the storylines, and the app monitors their behavior. This information is provided to the creation platform 200, and then to the creator. The creator monitors the activity of the various users with respect to each storyline. From this information, along with the analytics, the creator gains insights and better understanding of user experience from which to modify the content.

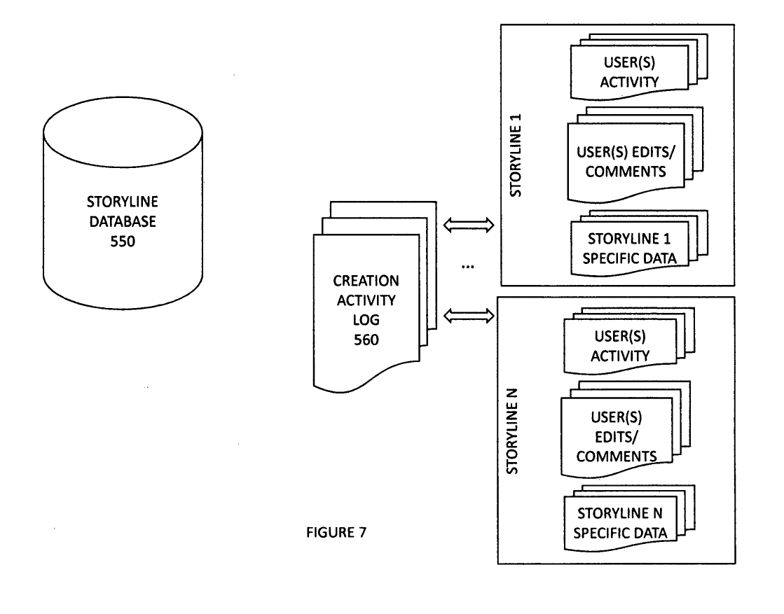

FIG. 7 illustrates a creation platform 200 according to an example embodiment storing story information, including a storyline database 550 storing core content. The core content may include multiple storylines for alternate or alternative versions and episodes. The storyline database 550 also stores a creation activity log 560 compiling information on each storyline, and corresponding user activity, user edits/comments, and storyline-specific data. The set of users associated with each storyline are not necessarily the same set, as the set of users is determined by the creator's evaluation criteria.

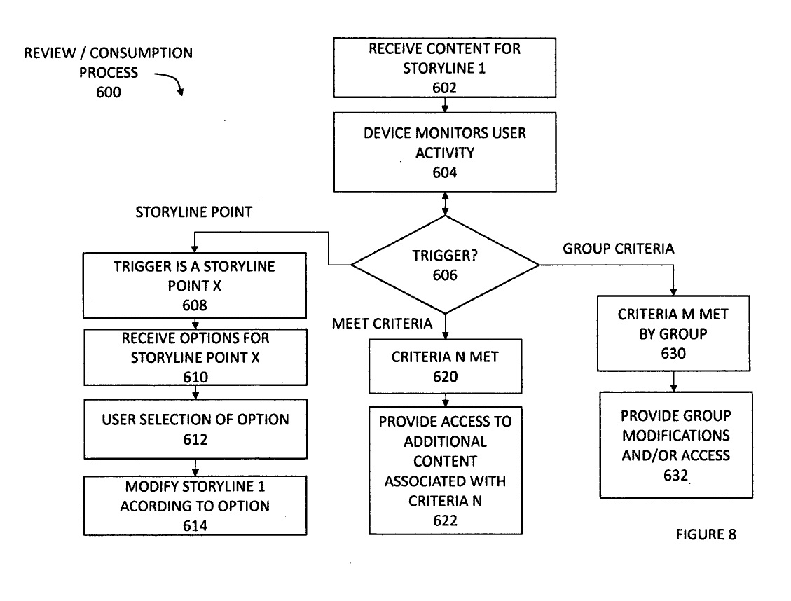

FIG. 8 illustrates an example of a review/consumption process 600, where the user receives content for storyline 1, 602. The user device monitors user activity, 604, during user consumption. As the user reads the content, they may come to a trigger point, 606, in the storyline 1. If the trigger is a storyline point, 608, the process determines which point and the user may receive options for next actions. Some storyline points may acts as level up actions to take the user to a new storyline. When the user selects the option desired, 612, the storyline 1 is modified or changed. The change may be to implement a new and different storyline. If the trigger, 606, meets a criteria N, 620, then the user receives access to additional content associated with the criteria N, 622. If multiple users meet a group criteria M, the creation platform 200 provides access to modifications or additional access.

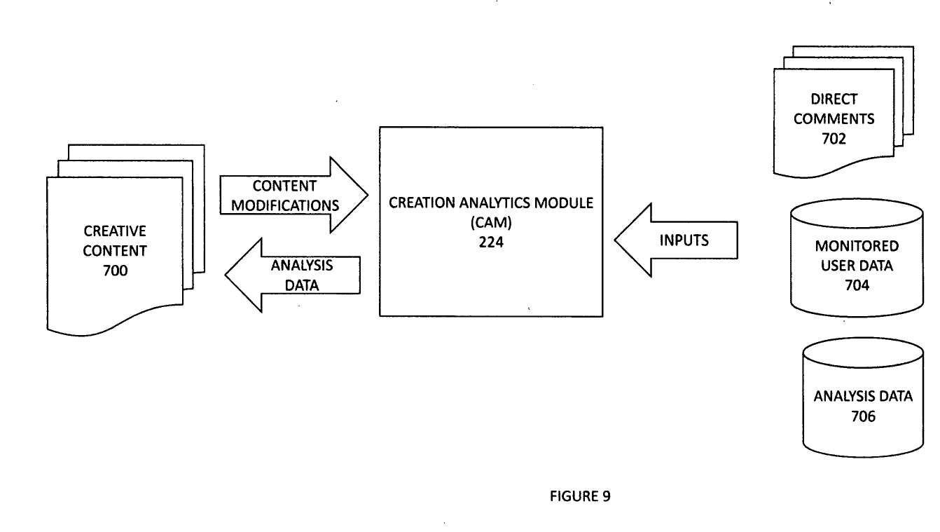

The review data is sent to the creation platform 200 and may be sent to the CAM 224 for analysis. FIG. 9 illustrates the work flow where direct comments 702 and monitored user data 704 are provided as inputs to the CAM 224. The CAM 224 stores data in analysis data storage 706. The CAM 224 analyzes review information and comments to provide insights to the creator. Creative content 700 is maintained both in the creator's device and at the creation platform 200. The creator receives analysis data, and sends any content modifications to the CAM 224. Modification information is used by CAM 224, as described hereinabove, to improve and refine analysis.

In addition to the modules illustrated in FIG. 2, the creation platform 200 also may include a game module 260 for coordination with game content. A toys module 268 incorporates models, designs and projections for building models of characters and objects from the storyline. The toys module 268 and game module 260 may include specific details of characters, objects, settings, scenarios and aspects of the story from the creator. This information is used to generate models and game features for the users.

A social interaction module 262 to receive information from social networks and share information. The social interaction module 262 may monitor activity on social networks to coordinate information relating to content. Creators may specify social networks to monitor and interact.

Augmented reality module 264 mixes real life objects, people, environments with the story. The creator may specify how the augmented reality is to respond to real life changes and events, and the augmented reality module 264 responds to these as triggers to set images, sounds and structures accordingly. For example, the augmented reality may change the lighting in a scene of the story in response to lighting conditions of the user. In one example the augmented reality module 264 causes the user's device to behave as a weapon in the story. When the user lunges forward with the user's device, a sword in the story lunges forward: In another example, a violent storm in the story causes the user's device to shake with the thunder and flash with the lightening. Any number of other scenarios may be implemented by the creator and creation platform 200.

Augmented reality module 264 incorporates algorithms for compressing visual data and presenting to a headset or other peripheral. In one example, the algorithm may incorporate a camera to capture environmental factors and specifics on which to build the augmented images. The augmented reality module 264 is capable of augmenting the video images with real life information as well as providing an augmented real environment so that the user's environment and digital experience are coordinated.

Augmented reality may incorporate facial capture for motion capture, and may present a transparent display through connected glasses or headset. This may integrate motion capture through tools available to the user device or creative platform 200, such as accelerometers, RFID, geolocation tools, temperature and weather information, and any number of aspects.

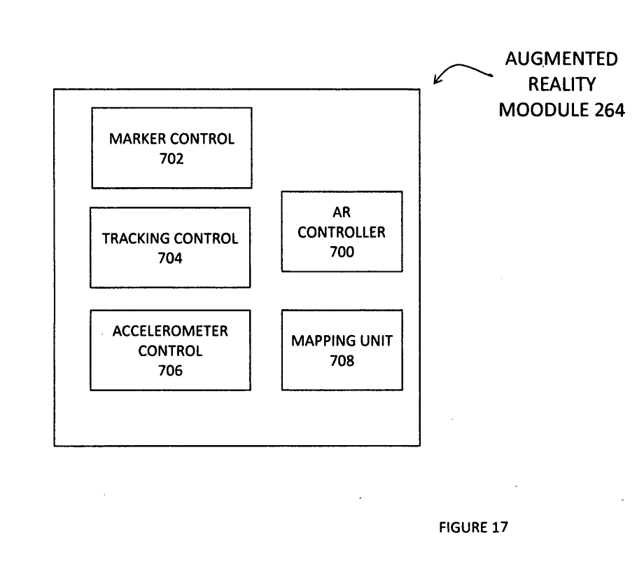

In some embodiments, the augmented reality module 264 incorporates marker data, which is accurate but may have occlusions, with accelerometer data, which is not prone to occlusions. Using the optimum benefits of the two techniques positional data is obtained without significant occlusions. The marker identifies the location, and the accelerometer adds velocity and rotation from that point until positional data is acquired again. This fills in the gaps associated with occlusion problems. As illustrated in FIG. 17 an example augmented reality module 164 includes marker control 702 to add markers to the content, a tracking control 704, an accelerometer control 706, an AR control 700 and a mapping unit 708 to coordinate operation of the accelerometer and marker systems on a user device.

The virtual reality module 266 interfaces with a headset or device that provides a virtual scene for the user. Signals are sent from the Virtual Reality (VR) device to the creation platform 200; the VR module 266 responds and sends signals to the VR device.

The creation platform 200 further includes environmental control module 272 to interface with controls in the user's environment, a competition control module 270 to implement user and creator competitions, and a multi-media format control 276 to coordinate content among various formats, such as text, video and game. The user avatar module 274 creates an avatar for the user based on the story and their preferences.

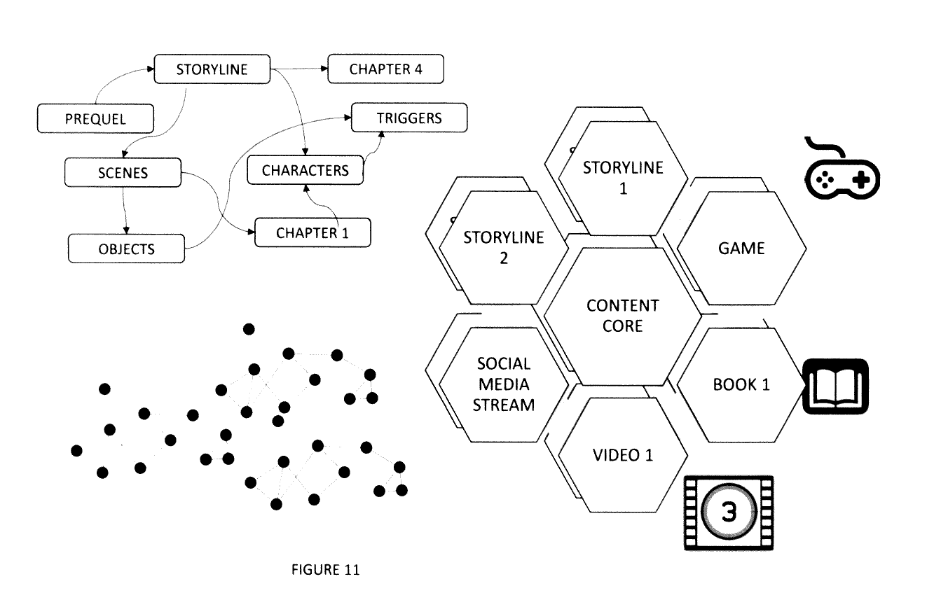

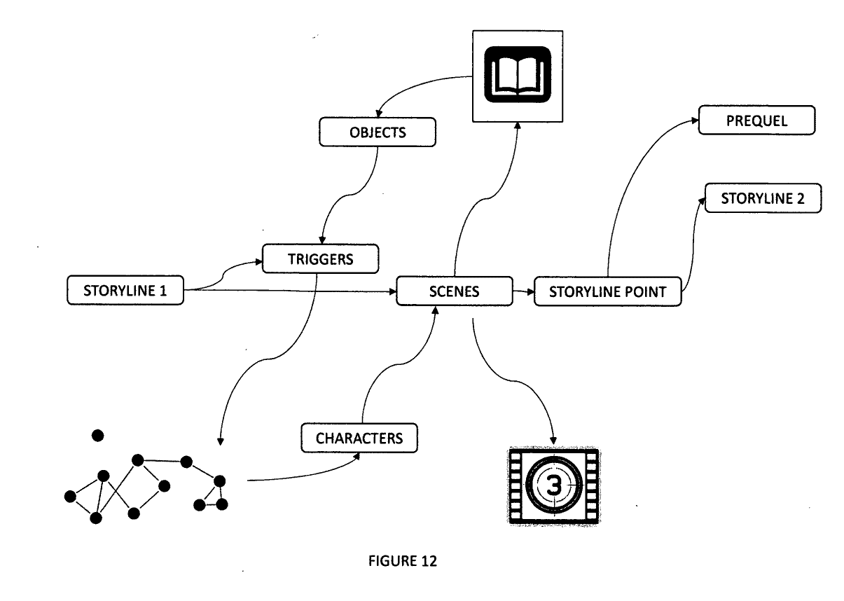

FIG. 11 illustrates the coordination of multi-media format control 276, where multiple formats are built on a content core. The creator may build out the content core into multiple storylines, books, videos, games and social media streams. The storyline, such as illustrated in FIG. 12, specifies characters, settings, objects, triggers, storyline points, and may be broken into chapters. These may each be reorganized and storylines may be added or coupled together.

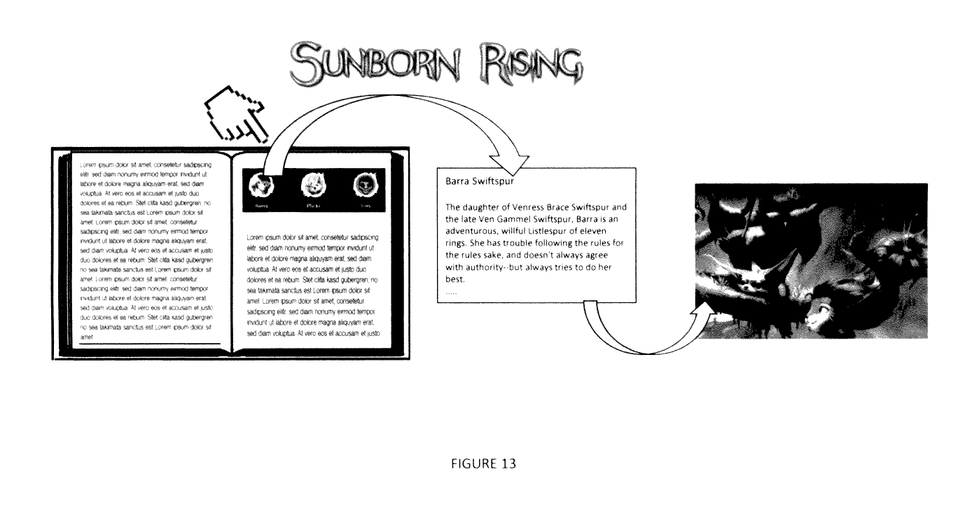

Another view of the interactions between media formats is illustrated in FIG. 13, where a physical book has text and graphics. User selection of a graphic image provides detailed information about the character, and leads to a larger, more detailed graphic image. There may be special images placed throughout the book, such as a flower that is mentioned in the book. When the user selects the special image it reveals detailed content. This is a way for the creator to present information to the user without excessive details in the storyline.

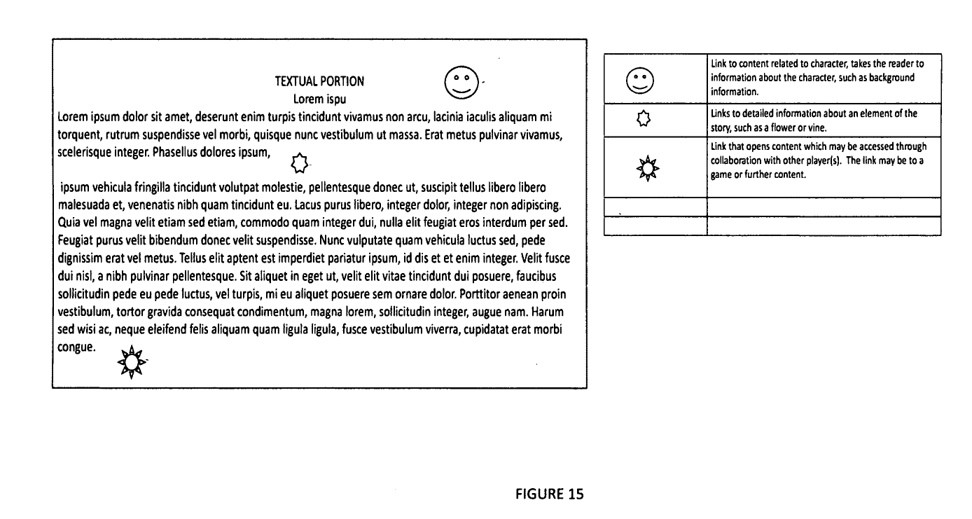

FIG. 15 illustrates a text example with images included within the text. Each of the images corresponds to a text or links or some other content information. When the user selects the image, the link or connection is activated and presented to the user. The creator may change the images for individual users or groups.

The creation platform 200 enables users to participate in the evolution and development of content. Analytics provide insights into trends across a genre or with an author and so forth. The trends may map to social networking trends. The analytics may also provide preferences for individuals and groups, gauge user interest and engagement, and the difficulty of getting through the material. The analytics may further identify portions of content that are of interest to most users. Such analytics may be used by creators to solicit expectations of users prior to accessing the material and then comparing this to the actual user experience.

Physical books may contain security information required to access electronic versions of the content, such as digital books, videos, websites, video games, audio files, social network sites, and so forth. The security information may be unique to a given book, such as an image on different pages in different locations. The security information may be a required answer to randomized questions. In one example, the user is asked to identify a specific word at a specific location within the physical book. The specific word and location are changed each time an access is attempted to the digital content.

As a user interacts with the digital book, or a physical book, there are coded portions of the book that link to other content. A coded portion may link to prequel type information that serves to explain and enhance aspects of the story that were not presented in the story line. These coded portions may link to different content based on personalization to the reader. The user's pattern of reading, accessing and interacting with the story is recorded and analyzed to determine information that the user would enjoy.

In some embodiments the coded portions may link to advertisements for products or services. These may be related to the story, game or other related content. The coded portions may be used for a variety of purposes, and may include interactions with other readers. In some embodiments, users may insert coded portions for additional information. This may include messages to leave for other users as they access these portions of the story. The user-generated coded portions are uploaded to the system and stored for presentation to other users. The user-generated coded portions may be shared with specific users or may be available generally. The user-generated coded portions may be presented in a game, to connect the game with the book or otherwise assist or challenge the user in progressing through the game. For example, the user-generated coded portions may inject clues and puzzles to be solved for access to additional content, help or items in the game.

The coded portions may be text, logo, bar or OR code, graphic element, or other item that may be selected or scanned, such as a graphic on the printed page of a physical book. Scanning the coded portion launches other content, such as in a corresponding game or other format. In physical book, scan image and information is sent to the user, which may be by email, SMS or text message, notification on a mobile device or computing device, presented within the digital book or game, or other messaging technique. In one example, by scanning a specific flower in the physical book, the user is provided details in the digital book or these details are sent to the user's mobile device. The specific information provided may be based on the user's reading progress through the digital book or progress in the game.

The digital content may include a variety of portions, such as a digital glossary, a map, and a graphic identifier. The collaboration network may include additional resources that creators and users may access. The content may require historical context or information not available in the current work. The creator or the creation platform 200 may make this information available to the user (and creator). The digital content may provide additional insight into where the various characters are in the content, such as the book. The characters may have corresponding files that may be used to build a model of the character, such as on a 3-D printer or other device. The character files may have hologram information, display information, graphic images for social distribution and so forth. The creation platform 200 may create this information to supplement the content. This may be in response to user suggestion, request or intrinsic analysis of user behavior.

The map may change as the user reads through the story or follows the content. For example, in a digital book as the user reads through one or multiple storylines or threads the system identifies the reading pattern and builds in additional content. This may consider the user's preferences and other activities with respect to the book, such as game play or audio book, and so forth. In some examples, a map may change dimensions or topography according to the user. A first reader may like a leisurely stroll through valleys, and another user may be cyclist that likes challenges. This may be built into the storyline or may be a trigger to change the map and/or storyline for each user.

The map may identify the location of all characters or specific characters as the user reads through the story or watches the video or plays the game. The map may provide hints or clues to the user as they play a game, which enable enhanced engagement. The hints or clues may be unlocked when a user achieves a certain goal, such as achieves a level, finds an object, plays for a given amount of time or pays a fee.

The creation platform 200 may incorporate glossary information that provides details about characters, storyline and aspects of the content. This information may include information about the creator. The glossary gives information and identifiers to give context to the content. The glossary and other resource provided to the user may identify specific portions where events occur, giving the user ability to follow foreshadowing, flashbacks, and so forth. The user may also add suggestions for these elements to the glossary.

The creation platform 200 may also provide location of characters along a timeline. This enables the user to better understand the interactions of characters. In one example, the user can identify that a new character was part of a previous interaction with a protagonist, but that is not provided until a later flashback in the story. The creator may use this user activity to modify the story. For example, if the creator implements foreshadowing to future events, the creator may desire to know if too much information is given. If the future storyline is easily predictable to users, the creator may desire to change the storyline to build suspense, surprise and so forth. The creator may also find that users are confused and therefore may modify the storyline or add historical views of the story. This may be provided as prologue information, supplemental or glossary information, or an overlaid video that plays at a specific point in the storyline of the text or game.

In some embodiments, the user has the ability to set a pointer in the storyline which may be used to access future content. In this way, the user may prepare to access sequel material, and this information provides the creator with information on interest and engagement.

The creation platform 200 provides links to additional media types as function of the user status. In one example, a paid up subscription may enable access to short form and animated movies, video games and information, fan fiction and stories, and other content. The links may be added dynamically to the digital content based on the user status, membership or other considerations. The links may also be embedded and or activated based on business and personal relationships. In some embodiments, this functionality extends to comments, feedback, highlight from friends, or links and embed material, such as from preferred authors, and so forth, which may be supplemental to any subscription/purchase relationship.

The creation platform 200 may also implement an account structure, where users may have multiple options or a universal account that subsumes all the account features.

The creation platform 200 enables the creator to take user inputs and apply to prior portions of the storyline. For example, where users indicate that the scenes of a video are too congested, the creator may simplify the scenes and retrofit this simplification into earlier scenes. In another example, character development of a character, such as protagonist or antagonist, is not well understood by users. The creator may modify aspects of the character's personality and fit these into the earlier storyline, as well as continuing forward in time with these modifications. Character introductions in a portion of the story may have associated historical information that is applied to earlier parts of the story. For example, a new character is introduced at a point in the storyline; the creation platform 200 creates historical views of where the character is introduced earlier, such as in prequel information. Similarly, the creator may desire to give future events, similar to foreshadowing, that hint at sequel information.

The creator may also want to incorporate how a storyline is impacted by a given character. For example, the creator may want to know what the story would be like without a character or story element. The creation platform 200 implements the change and receives feedback from the users.

Alternate options are available to make other changes to the content, including environmental changes, dialogue changes, relationship changes and so forth. The creator may modify a static character into a dynamic character, add humor or situational irony to the storyline, enable users to add commentary directly to the content.

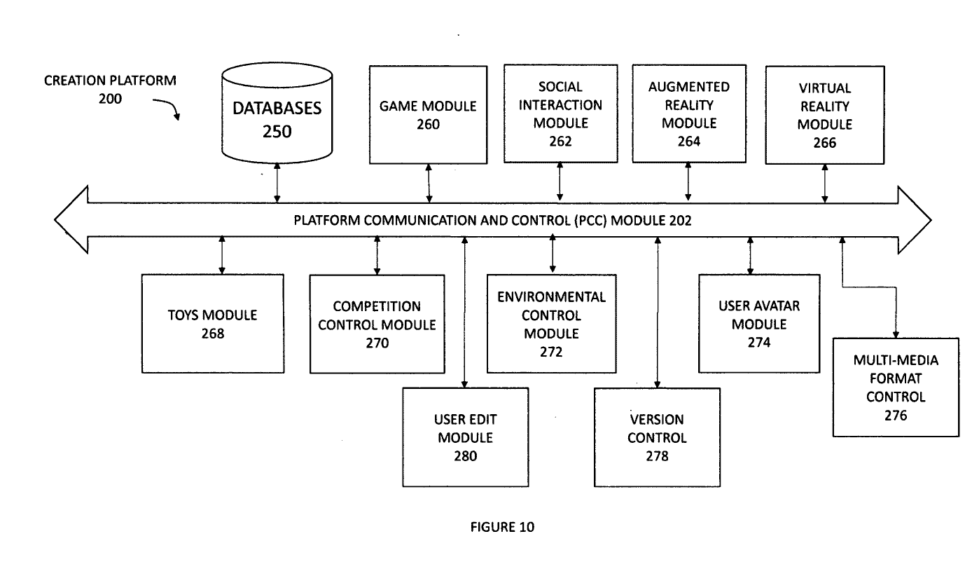

The ability to adapt the story to a user provides version control. As illustrated in FIG. 10, a version control module 278 manages different versions and content in the storyline. In this way, the core content may be written as a children's story, but may be adapted to different age groups,

A map may be presented to illustrate the user's progress through the book, such as to show the environment of the current scene. The user may have an avatar that follows the story thread. The user may select their avatar, and may develop a character through their avatar. Their avatar may be part of the story, or may be injected as a spectator. The creator may develop content to interact with the avatars. The map may indicate the location of characters at a given time, and throughout the timeline of the story. The creator may adapt the story to follow trends or user preferences. The creator may test out specific content and combinations of content on specific users or groups. The digital content is stored in the creation platform 200, and is supplemented by analytics and other insight data. The insight data may be quantized according to analytics, preferences of the creator, general learnings, and so forth.

The system may provide a historical view of the story according to story threads. These historical views may be altered to apply information to previous scenes, such as where the environment changes or alters later in the story. These later developed changes are applied to earlier parts of the story. For example, where a new character is introduced later in the story, the system may present a historical view where the character is introduced earlier in the story, demonstrating how the earlier part of the story would be impacted by the character. Alternate options may implement environmental changes, dialog changes, relationship changes, and so forth.

Interaction of the various content formats, such as books and games, are controlled through a universal account. The universal account is specific to the user or a group of users and acts to connect the various content formats. The activity of a user or group as they interact with the content may unlock other formats or features. The universal account enables access to features experienced or achieved in one format to be used in another format. In this way, tools used in the game may be input into the digital book. The book may then explain the history and specification of the tool. The information presented in the book about the tool will aid the user in playing the game. In some embodiments, the digital book progress unlocks capabilities in the game, similar to a power-up common in video games. The creators and users have flexibility in forming complex interactions, such as to require consumption of various formats to proceed through any of the content, or to access enhanced content.

The creation platform 200 provides a variety of portals into the content. These portals may be located at various points within the story, such as locations or times on the storyline. In this way, the user may access the story or environment from any of a plurality of different entry points. In one situation, the reader enters in the middle of the story, where the information missed may be presented as a prequel. The environment data may be supplemented with resources, tools, and information provided by creators, the creation platform 200 and users. The creation platform 200 builds a network of resources and tools to enable creation of content by the creator and/or the users.

The user may enter a story as a character that is not written into a scene. This enables the user to add to the storyline and incorporate a new character into plot, dialogue and so forth.

The prequel type information may explain aspects of the story as introduced by the creator or requested by users. The prequel information may include enhancements to the user's understanding and enjoyment or may provide elements developed in later content formats. Prequel information provided in a book, may provide a starting point for a movie, or may be incorporated into a game.

Prequel information may be embedded according to a user's reading patterns and behaviors. The creation platform 200 may integrate prequel information according to user interactions or as determined for user enjoyment. The prequel may also link to advertisements and/or products, services, and so forth. The ability to integrate advertisement, recommendations and other user promotions provides a potential revenue stream to support the creative process.

The creation platform 200 may indicate statistics associated with the content. In some embodiments, statistics include the social interactions, such as to identify the number of readers currently reading the book, the number of users editing, the number of users interacting with each other and/or the creator. Such information may open up social networking opportunities, where a group of readers may share current thoughts and impressions of the content. The creation platform 200 receives the usage information and routes information according to information provided by each user. A user may specify that the system may contact them or connect them with a group of other users, such as friends or connections. The user may allow the system to provide notifications to connect with users or groups as they become active in the system. The user may suggest other users with whom they would like to connect, and the system will contact the other users and complete the connectivity.

Compiled statistics are managed by CAM 224 and are available to the creators to better understand reception and engagement of the audience. The statistics may include when users stop reading content, what are the conditions, and how long until they pick up the content again. The timing statistics may be compiled and supplemented with environmental and social information. The user's patterns of reading, or consumption, of content may provide key insights into content for authors. This may be coupled with information on how fast people read, or how fast an individual user reads. This may change due to environmental conditions or behaviors, such as time of day, day of the week, time of year, geographical location of user, family size, hobbies, profession, preferences, activities and so forth. The CAM 224 may determine the point within the story at which users stop reading or pause. This may correspond to action in the story line, the plot, character engagement and so forth. There may be lulls in activity that provide good stopping points and easy reengagement when the user returns to the story. This is also applicable to videos, games and other content, as user consumption behaviors and patterns may dictate their consumption. The statistics may indicate users access to resources, such as dictionary or thesaurus access, the number of times and frequency of resource access, links to other content and so forth. This provides the creator with information as to where to add an in-app dictionary or other resource, or the lack of interest in such resources within content that may simplify the build for a creator.

Further statistics and insights include the type and volume of notes and comments from users. The creation platform 200 may provide in-line comment support for content. For video content, the creation platform 200 may provide tools that allow a user to drop or input specific icons or objects, each having significance. In one example, the user may add a lightbulb to indicate the scene is too dark. In another example, flowers are provided to drop into the video while it is playing; the flower indicates that more foliage should be added at this point. These indicators may be moved onto the content by touch screen, or may be a control typed into a control box presented on the display. The video comments are particularly useful to a creator.

In some embodiments, the user may implement changes to the video content, such as to select lighting, colors, position of characters, clothing for the characters, and so forth. In one example, a user may replace a stick with a sword, or a small flower with a vine. These changes may be taken from a template of available options, and may be imported from external resources. Users may create content and submit for inclusion in the content. The flexibility of the creation platform 200 enables any of a variety of collaborations and creation scenarios.

The creation platform 200, as illustrated in FIG. 10, may include a user edit module 280, which enables user's in-line and in-video comments. Users may present defect or bug reports to the user edit module 280, which compiles and provides to the creator for corrections. The users may input these directly into the content.

Social interactions through the creation platform 200 include distribution of updates, notes, newsletters, announcements and social information to users and creators. Participants may submit information for distribution through the creation platform, wherein the credentials for submitting, approving and distributing information are controlled by the notification module 208. The creator or the creation platform 200 may determine the criteria for social interactions.

Users may desire anonymity and privacy, which the creation platform 200 provides, by isolating user information from other users and the creator. In this case; the user's data and information is anonymized by the CAM 224. Where specific user information is sufficient to identify a user, that information is withheld from the calculations and/or information sent to the creator and other participants.

As illustrated in FIG. 10, a multi-media format control module 276 interfaces with the formats supported by for a work of content. The media may include physical media, such as books, board games, models, toys, stickers and so forth. The media may include video content, such as video games, movies, short videos for websites, advertising videos, testimonials and so forth, presented in a video or streaming format. The media may include digital or electronic books, including text, graphics, links, resources and so forth.

The creation platform 200 incorporates coding to some content, such as books, to link to other content. The variety of content developed in various formats, environments, and media are interactive, enabling enhanced experience with content. The creator starts with a core content in a first format; from the core content additional content is developed. The creation platform 200 provides the coding for such interactions, linking and cross-development. The variety of content may develop along different storylines so that users continue to experience new and different threads of the story.

These various media formats may be coordinated so that edits or modifications to one are also available to modify another format. For example, where a user suggests that a character be added to a scene by in-video edits, these edits are also prepared for each of the other media formats. The creator makes decisions about content for publication. In some embodiments, users may develop their own story by incorporating such edits or modifications where the creator has rejected them. Additionally, users may create their own personal versions of a story or content, for their enjoyment. This user behavior is tracked and monitored by the creation platform 200.

The creation platform 200 is flexible and supports multiple user and creator devices. As new devices, operating systems, peripherals, controllers and so forth are developed, the collaboration network 50 may source solutions to interact with these also.

To protect the digital content, digital rights management (DRM) may be used to unlock the digital book when a user has rights to the physical book. When accessing the digital content, a digital book or video game, the user is prompted to enter security information from the physical book. The security information may be randomized questions related to the physical content, such as to identify a specific word at a location on one of the physical pages of the book.

Content formats include video games which present the content in a game format. Users interact with characters in the story as they progress through the game. The game shares content elements with the book, and the system enables connectivity there between. The game module 260 controls operation of video games, quests and other interactions. Multiple users may engage with the game concurrently or asynchronously. A first user may leave objects, messages, videos and other content for another user to find and access. This may implement a scavenger hunt type experience or may enhance a quest story. The CAM 224 uses this information and actual usage to provide feedback to the creator. The creator may hide content, such as challenges, in the content. These are accessed by users as they engage with the content. Challenges may be presented in any of the formats, as these may be dynamically modified based on user interaction. A challenge to a reader may require submission of an answer or response. The CAM 224 monitors the steps taken by the user to respond to the challenge and their ability to complete the challenge, as well as the timing associated. The challenges may be presented to a group, wherein the entire group may work together to meet the challenge or solve the puzzle. Such collaboration enables users to move faster through a story or content or to reach different levels. In some embodiments, the collaboration enables users to access content out of chronological order, such as to provide spatial order to the story. Collaborators may desire to engage with different scenes over a variety of time periods. In one example, a story plot involves a fantasy world that lives in the top of trees. The characters move throughout the top of the trees and this where most of the action in a scene takes place. The story later moves to the forest floor, where a different set of characters and creatures live. Users are able to watch the story unfold from the forest floor and see what is happening there during those scenes where the plot or action is happening in the tree branches above. In another example, a story involves fish and animals in the sea. The users may desire to see the underwater world through the eyes of a whale or octopus, rather than through the perspective and voice of the narrator. The creation platform enables these views and experiences.

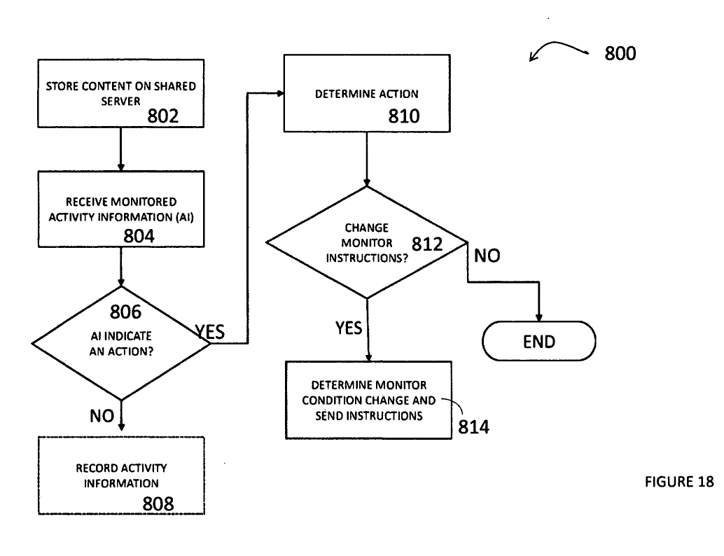

FIG. 18 illustrates a process, 800, for creation collaboration in creation platform 200, starting with storing content on a shared server, 802. The creator's device receives monitored activity information, 804 and determines if an action is indicated, 806. Where no action is indicated, the creator's device records the activity information 808. If an action is indicated, 806, the creator's device determines the action, 810, and determines if there is a change in the instructions governing user monitoring, 812. If a change is made, the creator's device determines the monitor condition to change and send instructions to the creation platform 200 at step 814.

The creators or users may inject messages into the content, which when found by others may promote further actions. The messages may connect others to a game or other content. The creation platform 200 may use user generated coded portions to inject clues, puzzles leading to additional content, help information or specific items in a game, or other content. In some embodiments the messages are text, logos, codes, or graphic elements that may interact with the user. In one example the message is a bar code, such as a QR code, that is scanned by the user device and leads to special content. In another example, the message is a graphic element that requires action by the user, such as a flower that is to be watered by the user. The graphic element responds to the user's action. The flower may grow, bloom or change into another form. A graphic image may be a cocoon that the user must place in a certain tree. Once in the correct location, the cocoon goes through stages and turns into a butterfly. The change to the graphic element may be predetermined, or CAM 224 may personalize the graphic element, the activity required of the user, and the resultant change, such as to incorporate music or other aspects that a user prefers.

Personalized modifications are monitored, saved, analyzed and used to make predictions and enhancements. Specific types of users may respond to challenges, and others may not. This information may be used to make challenges more enticing to the latter group or more difficult for the former group.

Physical to digital interactions are controlled by the creation platform 200 but are flexible to adapt to users and creators. In one example, a physical book has an image of a flower. The user may scan the flower image to obtain details about the flower or to jump to portions of digital content where the flower is presented. As the story develops and new objects, aspects and features are added, the creators may add connections from the physical content to these new features. Similarly, users may add interactions that are meant as feedback for the creator, enjoyment of other users or as part of their own interaction with content.

The cross-interaction across formats enables features achieved in one format to be accessed in another format. In some embodiments, a user may read to a story point A, which corresponds to a place in the video content. When accessing the video content, the user may jump directly to the story point A in the video. This enables continuation of engagement such that the user may desire to experience video portions while reading a book and vice versa. This may also be used to advance through a game. As the user reaches story point A in the book, they are able to access game features associated with story point A. This ability may be shared across a group of users. Such interactions provide feedback to CAM 224 for analysis of the story across media.

The game enables the user to take any of various paths through the story, each path forming a story thread. The content elements may change depending on the order in which they are accessed or where they appear on the timeline of the story. The user's thread may be recorded and stored in memory, either at the server or on the user's device. The user's threads may be combined by the system to enable the game to evolve and develop in response to user activities. The system may also build a new story or continue the timeline as a function of user activity and access. The story evolution and development provide information to the author as to the interest and engagement of readers. The story may serve as a seed for development of a series of stories or threads.

In some embodiments, the game incorporates or requires multiple players to achieve a goal or reach a given level of the game. The system coordinates and tracks the player instances to enable users to work together. Collaboration may make the users move through the game faster or open up hidden levels. The system acts as the interface between users, and may record the various user activities and how they work together.

Users may interact with each other, as well as creators, through the creation platform 200 to play games. Users may interact with characters, as the creation platform 200 may include information about each of the characters sufficient to predict their behavior, actions and dialogue. Multi-player video games enable collaboration and interaction among users as they progress through the game. This includes connectivity between multiple formats, including games, books, videos and so forth. The users may incorporate their experiences into social media and networks.

In some embodiments, each user's personalized threads are stored in memory, either at a central location, a distributed network of memory locations or on user devices. The user may control the threads, such as to limit access to their threads. A user may share threads with friends, and access each other's threads. Threads may be overlaid or realigned to a different time or environment. A thread may include the actions taken by the user while they play the game, and include access to other stories that are provided by the system. This enables characters and events in one story to be shared by other stories. For example, a fairy in a children's book may be applied to another story and rescue other characters that are in need of a fairy.

The ability for characters in different stories to interact and share experiences, enables characters to be seen in a different settings and scenarios, expanding their scope. Similarly, the mood or tone of one story may be applied to a different story, using author's language and word choice as applied to new and different stories. While tone is the author's attitude toward a subject or character; the mood reflects the emotion evoked in the readers. The author of the story and content writes to achieve a given mood, however, the author does not always understand the resultant mood. The interaction of the reader with the story and the feedback provided through their interaction with the content, is provided to the author, and gives information as to the reader's experience and feelings. The system has capability to provide feedback to the author or content originator, which may be used to revise, enhance or explain the content.

The system may analyze the threads of users to determine how user's use and enjoy the content. The analytics provide almost real-time information to the author. The threads may be analyzed with respect to a variety of other user signals, such as geographical location of the user and other information retrieved from the user's device. User information may be coordinated with social networking sites and communities, to enhance the user's information. The feedback may be focused on aspects of the user's life that are related to the content.

Users and creators have capability for interactions and creative development. A story is typically made of separate threads or storylines. A thread may be a small digression from the storyline, or may be a supplemental portion added to a storyline. Users may create specific threads and store these in memory, for recall or reuse in multiple stories. The users may create threads specific to their personality or interest. For example, a cyclist may add a thread where a character goes for a bike ride throughout a fantasy world, enabling the user to explore the world in detail, and may provide aspects to the story of interest to cyclists. Similarly, a waterway may be explored by rowers, or a mountain by hikers. Young girls may want to investigate a character's closet for dress ideas, or change the clothing on a specific character.

Collaboration on games may provide unique user experiences. The concept of crowd-sourcing information provides a robust review for creators. Users not only provide feedback to content, but may build on that content by adding a new storyline, thread, timeline, character, and so forth. The creation platform 200 supports personalized threads, characters and events intended for personal use of a user or group of users.

As in other venues, the characters in a story may be shared or appear in other stories. There is potential for creators to present characters in the stories of others. Where a creator writes a story with a character Bara, the creator may be a user for another author writing a different story. The creator of Bara may suggest that Bara have a cameo appearance in the different story. Similarly, sounds that are unique to one story or series, such as the sound of a light saber, may be applied in other stories to surprise or amuse readers. Various aspects may interact between content, such as tone, setting, scenarios, objects and so forth.

Interactivity enables information presented to coordinate between game play, content consumption and creation of content. The creation platform 200 may act as a service to coordinate progress of various users through a game or other content. This information is used to evaluate the game and provide use statistics to the creator. Coordination of content may limit access within the game based on progress in the book or may alter the game based on user behavior feedback with respect to the book or video. For example, a game may be modified to avoid violence for a young reader or someone that does not react well to suspense. The user feedback provides information shared across media, such as to position details throughout a game or book. A user may prefer a specific color, or may prefer to hear one character speak in an Australian accent. This may be incorporated into the game for that user or tested on other users.

In some embodiments the characters in a story interact with the users, asking them questions, giving comments, and sharing information. In one example, a character asks the reader if they should climb a tree or take other action. In this way the user may collaborate not only with users and creators, but also with characters and elements of a story. These character-to-user interactions may be across media, across stories, across programs, applications and so forth. The user may desire to use a character voice, song, or sound as a ringtone on a mobile device, or build these character aspects into other applications. The collaboration may also involve users inviting others to participate in review of content. In some scenarios, the users are not providing direct review, but rather are asked to enjoy the content and the monitored information and resultant conversation among users gives sufficient information and feedback to the creator.

In some embodiments the creator or the creation platform 200 provides different portions of content to different users. The content experience is similar to a short story, and provides feedback to the creator on each portion. The portions are then shared among users for further engagement and feedback.

As discussed hereinabove, the system enables collaboration between users. Multiple users may act together to generate or suggest new creative works that alters or amends the content. The users may provide details to the author or content generator, who may join a group to collaborate with users or who may request specific information from users. The users may request others to comment and/or interact with crowd-source information related to the content. This may be done in the content, such as in the book format or game format. This content may add to the complexity or simplicity of the content. For example, the complexity of the game may create changes or enhancements to the story environment; users may create features to develop content elements, such as to grow new plants or change the growth path/potential of existing plants. Buildings may change shape and dimension. The creator may give instructions on care of a plant, where opportunity is provided to the users at set points in the story or game implementation. This may change lighting, or have other results.

Inanimate objects may be personified to speak or interact with characters. The range of changes are determined by the users and author. There may be any number of threads and changes. Where users include those with more information and expertise related to a given subject matter, these users may add information to help the author make the story more realistic. For example, in a book that takes place in a specific country, a user that is a resident of that country may provide specific information to correct specifics given in the story that are not accurate, or may add colloquial information that may not have been available to the author.

For creative additions and modifications to content, the content features may be sold to users for use in the game or for access through the story in the digital book. The system provides a platform or opportunity for users to trade and sell items that are created in the game or book. The users may challenge other users with puzzles. User may mix content elements to create combined content elements and features. Users may create new content elements to work with the story and content. When a user creates a new content element, such as an object, plant, animal, environmental item, and so forth, the user may provide a recipe or specification for that new content element. A user creates a plant having a specific appearance, life cycle, function, growth potential, requirements for growth, and name. The user may give instructions to others for how to create or grow the plant.

Users may get to a specific setpoint in the story and/or game, and thereby achieve a goal that changes the lighting or other condition of previous levels of the game and/or chapters of the book. For example, when the user has read the first third of the book, the lighting used in the environment gets brighter; the user may apply this increased lamination to earlier chapters to see how this would change the previous story.

The creation platform 200 provides a creator dashboard, which is a centralized compilation of information providing an overview of the review process. The versions created and the information received for each modification are listed. The creator dashboard provides statistical information on users that provide review information, and enables a creator to identify those participants that add the most significant inputs. The creation platform 200 also provides a user dashboard to monitor their participation in various projects.

As users move within a given content format, actions may serve to provide access to other formats. The server provides a platform for these interactions. As a user engages in multiple content formats, various points in each content format may link to points in other content formats. The content presented between the various formats intertwines to enable a common experience for the user. While playing the game, the user may be presented with explanation, details, and guidance as appropriate. By tracking the users' game interaction, the system is able to identify locations to provide details to the user, wherein the information presented is coordinated with where the user is in reading the book. The information presented may also be personalized to the user. The user may be at different points in each content format, which may limit the experience in one or multiple of the formats. For example, if the user is farther along a timeline of the game than in the book, the server may limit access to certain information in the game to avoid spoiling the story development for the user.

In addition to personalization to the user's access of the information, some embodiments employ user collaboration to unlock content. In one/example, the system calls for multiple users to work together to achieve a goal. Each user may be required to take an action and pass information to another user. When the goal is achieved, the system will unlock additional content. In one example, the system provides clues or hints to the necessary actions t achieve the goal, such as where the users find hidden items, or users are required to apply inductive reasoning to predict a next action or item in a series.

The system stores information on each of the various users, including current usage and status. The system may incorporate the user information to build an augmented reality adding in features of the user's environment or aspects that the user suggests or adds. Characters from the story may be used to interact with the user in other applications and programs, such as to be part of a ringtone for a cellular phone, or as the digital personal assistant on a mobile device.

Analytics

The system includes a database of information received from users. Analytic engines apply the information to a variety of considerations. The content generator may use this information to better understand the users' interaction with the content. In some embodiments, the user's reactions are monitored and compared to the expectations prior to accessing the content or specific portions of the content. During the story, the user's reactions may be measured and monitored. Comparison of people's reaction to their expectation provides authors with information as to audience value, and provides feedback to the author as to how the work is received.

User interest based on access format, biometrics, multi-player activity, collaboration and other user preferences. This information may be used to determine patterns, anomalies, preferences, trends and similarities in user groups. These analytics are automated in the system to identify, track and suggest these parameters.

The creation platform 200 acts as a platform for collaboration and development among users and content generators. Users may participate in the evolution and development of content both indirectly and directly. Users provide indirect influence through their access and use of the content in one or more formats. Users provide direct influence through creative additions and enhancements. In this way, a single content may result in multiple projects, each having multiple threads and timelines. These projects may be universal to the various content formats, wherein a user may specify how to express each new content element and feature in each content format. The creation platform 200 and the processes supported are applicable to a broad array of projects.

1. A digital content user interface system, comprising:
a user interface module for interacting with a distributed network of devices;
a content management module for:
receiving digital content from a first device in the distributed network of devices,
identifying a second device for receiving the digital content;
sending the digital content to the second device with instructions for processing the digital content; and
receiving information from the second device relating to the digital content; and
an analytic module for generating statistics from the information and providing the statistics to the content management module,
wherein the content management module sends the statistics to the first device.

2. The user interface system of claim 1, wherein the digital content the information form the second device and the statistics are stored in a database.

3. The user interface system of claim 2, wherein the digital content is in a first format for a book and has a corresponding second format for a video work.

4. The user interface system of claim 3, wherein the first device sends a second digital content for the second format to the content management module.

5. The user interface system of claim 4, wherein the information from the second device includes usage data, wherein the first device modifies the digital content in response to the usage data.

6. The user interface system of claim 1, wherein the first device provides instructions for use of the digital content.

7. The user interface system of claim 6, wherein the second device provides feedback information to the user interface.

8. The user interface system of claim 1, wherein the analytic module measures interactions with the digital content to determine user interest.

9. The user interface system of claim 1, wherein the analytic module monitors user interactions with the digital content and generates statistics of these interactions.
